(19) United States
(12) Patent Application Publication
(10) Pub. No.: US 2014/0109162 A1
(43) Pub. Date: Apr. 17, 2014

(54) SYSTEM AND METHOD OF PROVIDING AND DISTRIBUTING THREE DIMENSIONAL VIDEO PRODUCTIONS FROM DIGITALLY RECORDED PERSONAL EVENT FILES

(71) Applicant: Benjamin Paul Licht, Delray Beach, FL (US)

(72) Inventor: Benjamin Paul Licht, Delray Beach, FL (US)

(21) Appl. No.: 14/140,699

(22) Filed: Dec. 26, 2013

Related U.S. Application Data
(63) Continuation-in-part of application No. 13/102,574, filed on May 6, 2011.

(51) Int. Cl. H04N 21/81; G11B 27/031; G06T 15/00; H04N 21/858

(52) U.S. Cl. CPC H04N 21/8166; H04N 21/8586; G11B 27/031; G06T 15/00; H04N 21/8153
USPC 725/113

(57) ABSTRACT

A method of providing and distributing personal video content that displays personal digital photographs as still images moving in three dimensional space is disclosed. Personal digital photographs are downloaded to a server. A user identifies a level of editing complexity from a plurality of levels of editing complexity. The user selects a three dimensional effect desired for a personal video from a plurality of preprogrammed templates stored at the server. The personal video is created that displays the digital personal photograph as a still image moving in three dimensional space according to the selected three dimensional effect. The user receives a link to a website hosting the personal video that can be shared with desired viewers.

### CROSS-REFERENCE TO RELATED APPLICATION

The present application is a Continuation-in-Part Patent Application derived from pending Non-Provisional U.S. patent application Ser. No. 13/102,574, filed on May 6, 2011, which is hereby incorporated by reference in its entirety.

### FIELD OF THE INVENTION

The present invention relates to a software system that modifies digitally recorded personal events or experiences and converts them into elaborate three dimensional renderings. More particular, the present invention pertains to a method for the conversion of personal digital photographs and personal videos into professional looking animation/motion graphics production videos and providing a website at which the animation/motion graphics production videos can be viewed.

### BACKGROUND OF THE INVENTION

Two-dimensional (2D) paper photographs have memorialized people's personal life events, such as, weddings, anniversaries, parties, baptisms, bar mitzvahs, and the like for generations. These paper personal photographs, after placement in binders or photo-albums, have become the conduit in which they are usually shared with family and friends. Not too long ago, the photo-album became a capsule of cherished memories, only to be shared occasionally, and eventually placed on a shelf to collect dust. Today, the memorialization of important life events has now been replaced with its digital counterpart. It is now easier than ever to memorialize an event by using a simple mobile device. Cellular telephones and computer tablets are now equipped with high resolution cameras making every mobile user a novice photographer. Even with digital photography, the photographer does little to transform that photograph into a fun, entertaining, and accessible photo. People usually get bored quickly from viewing the same photographs on a computer. Accordingly, as with paper photographs, digital photograph files are usually left on a computer hard drive to collect digital dust.

After the Internet and cellular revolution, delivering digital photographs to family and friends has changed. Advancement of cloud based services has allowed more people to display their favorite personal life moments at social networking websites, such as FACEBOOK, INSTAGRAM, or PINTEREST. Personal digital photographs are now increasingly delivered by way of mobile, email, or by website posting, than by any other means. Distribution might have changed, but because photographs are shown in their static form, they are not being used to their full potential. A more memorable way to distribute and share personal digital photographs would be to convert the static 2D digital photographs into lively movies, or video with three-dimensional (3D) renderings. One reason for the stagnation of 2D digital photographs is the lack of knowledge of using complex editing software and the high cost of hiring someone with that knowledge set. Many people who wish to share their personal photographs do not possess the skill to use complex software now available to convert digital photographs into a video presentation. Others do not wish to pay the high costs associated with the software. Additionally, hiring a specialist to produce such videos is cost prohibitive as well.

The term “motion graphics” was popularized by Trish and Chris Meyer's book about the use of ADOBE After Effects, titled “Creating Motion Graphics”. This was the beginning of desktop applications which specialized in video production, but were not editing or 3D programs. These new programs collected together special effects, compositing, and color correction toolsets, and primarily came between edit and 3D in the production process. This “in-between” notion of motion graphics and the resulting style of animation is why it is sometimes referred to as 2.5D.

Motion graphics continue to evolve as an art form with the incorporation of sweeping camera paths and 3D elements. Although many trends in motion graphics tend to be based on a specific software's capabilities, the software is only a tool the broadcast designer uses while bringing the vision to life. Lending heavily from techniques such as the Collage or the Pastiche, motion graphics has begun to integrate many traditional animation techniques as well, including stop-motion animation, cel animation or a combination of both.

One of the most popular motion graphics tools is a particle system; a motion graphics technology that is used for generating multiple animated elements. This type of animation is commonly referred to as procedural animation.

The high level of complexity of many video editing software applications is particularly problematic, given that people who wish to share and view personal family photographs often have a low level of computer and Internet proficiency. Even people with higher computer proficiency may not possess the patience, or time required to learn and utilize prior art software to generate videos to present digital 2D photographs. There is also a level of creativity that is required to generate visually appealing videos that some people may not possess.

Therefore, a need exists to overcome the problems with the prior art as discussed above.

### SUMMARY OF THE INVENTION

The invention provides a method of creating and distributing three dimensional video productions from a personal digital photograph that overcomes the hereinafore-mentioned disadvantages of the heretofore-known devices and methods of this general type as discussed above.

With the foregoing and other objects in view, there is provided, in accordance with the invention, a method of providing and distributing personal video content that displays personal digital photographs as still images moving in three dimensional space, where the method includes sending a digital personal photograph to a server and identifying a level of editing complexity from a plurality of levels of editing complexity; and editing at the identified level of editing complexity by selecting a three dimensional effect desired for a personal video from a plurality of preprogrammed templates stored at the server. The method further includes receiving a link to a website including the personal video, wherein the personal video displays the digital personal photograph as a still image moving in three dimensional space according to the selected three dimensional effect, and forwarding the link to a personal electronic device associated with a desired viewer.

In accordance with another feature of the present invention, the link is a hyperlink.

In accordance with a further feature of the present invention, the method further includes receiving an email including a hyperlink to the website and wherein the website is hosted by the server.

In accordance with a further feature of the present invention, the method further includes sending an audio music file and wherein the audio music file is included in the personal video.

In accordance with a further feature of the present invention, the method further includes sending text and wherein the text is included in the personal video.

In accordance with the present invention, the plurality of levels of editing complexity include a beginning level, an intermediate level, and an advanced level.

In accordance with another feature, the three dimensional effect includes rotating the digital personal photograph.

In accordance with yet another feature, an embodiment of the present invention further includes a method of providing and distributing personal video content that displays personal digital photographs as still images moving in three dimensional space, where the method includes receiving a digital personal photograph at a server; storing the digital personal photograph in a database of the server; and receiving a level of editing complexity selected by a user from a plurality of levels of editing complexity. The method further includes providing editing options to the user in accordance with the selected level of editing complexity; receiving an editing option selected by the user, wherein the selected editing option includes a three dimensional effect for a personal video; and creating the personal video displaying the digital personal photograph as a still image moving in three dimensional space according to the three dimensional effect. A link to a website including the personal video is sent to the user.

In accordance with yet another feature, an embodiment of the present invention further includes a method of providing and distributing a personal video production that displays digitally recorded personal events as moving in three dimensional space, where the method includes sending a digitally recorded personal event file to a server, wherein the digitally recorded personal event file is one of a digital photograph and a personal video and identifying a level of editing complexity from a plurality of levels of editing complexity. The method further includes editing at the identified level of editing complexity by selecting a three dimensional effect desired for the personal video production from a plurality of preprogrammed templates stored at the server and receiving a link to a website including the personal video production, wherein the personal video production displays the digitally recorded personal event file as an image moving in three dimensional space according to the selected three dimensional effect. The link is forwarded to a personal electronic device associated with a desired viewer.

In accordance with another feature, the three dimensional effect includes rotating the digitally recorded personal event file image.

Although the invention is illustrated and described herein as embodied in a method of creating and distributing three dimensional video productions from a personal digital photograph, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention regarded as novel, it is believed that the invention will be better understood from a consideration of the following description in conjunction with the drawing figures, in which like reference numerals are carried forward. The figures of the drawings are not drawn to scale.

Before the present invention is disclosed and described, the terminology used is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” “mobile application,” “application,” and the like as used herein, are defined as a sequence of instructions designed for execution on a computer system. A “program,” “computer program,” “mobile application,” “application,” or “software application” may include a subroutine, a function, a procedure, an object method, an object implementation, an executable application, an applet, a servlet, a source code, an object code, a shared library/dynamic load library and/or other sequence of instructions designed for execution on a computer system.

In this document, the term “mobile device” should be understood to mean a handheld computer or a small handheld computing device, typically having a display screen with touch input screen and/or a miniature keyboard. A mobile device as disclosed herein should not be limited to IPHONE or ANDROID mobile phones or tablet devices.

### BRIEF DESCRIPTION OF THE DRAWINGS

The accompanying figures and reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a flow diagram illustrating a process that utilizes a software system to create video productions simulating 3D movement of 2D digital photographs in accordance with the present invention;

FIG. 2 is schematic diagram of an embodiment of the present invention, showing how a user's digital files are converted into video productions and distributed;

FIG. 3 is a schematic diagram of an embodiment of the present invention, showing how the user's digital files are modified in accordance with different user-selected levels of computer and Internet proficiency and then distributed via the Internet; and

FIG. 4 is a block diagram of an exemplary network in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient process utilizing web-based software that allows a user to create professional looking digital videos, without the costs and complexity associated with a professional video production. Embodiments of the invention provide for a method of creating dynamic video productions that present static personal digital photographs as objects moving in 3D space. In addition, embodiments of the invention provide for tailoring video editing options according to a user-selected computer proficiency level and also, immediately distributing the final digital creation to many people using the Internet.

Network

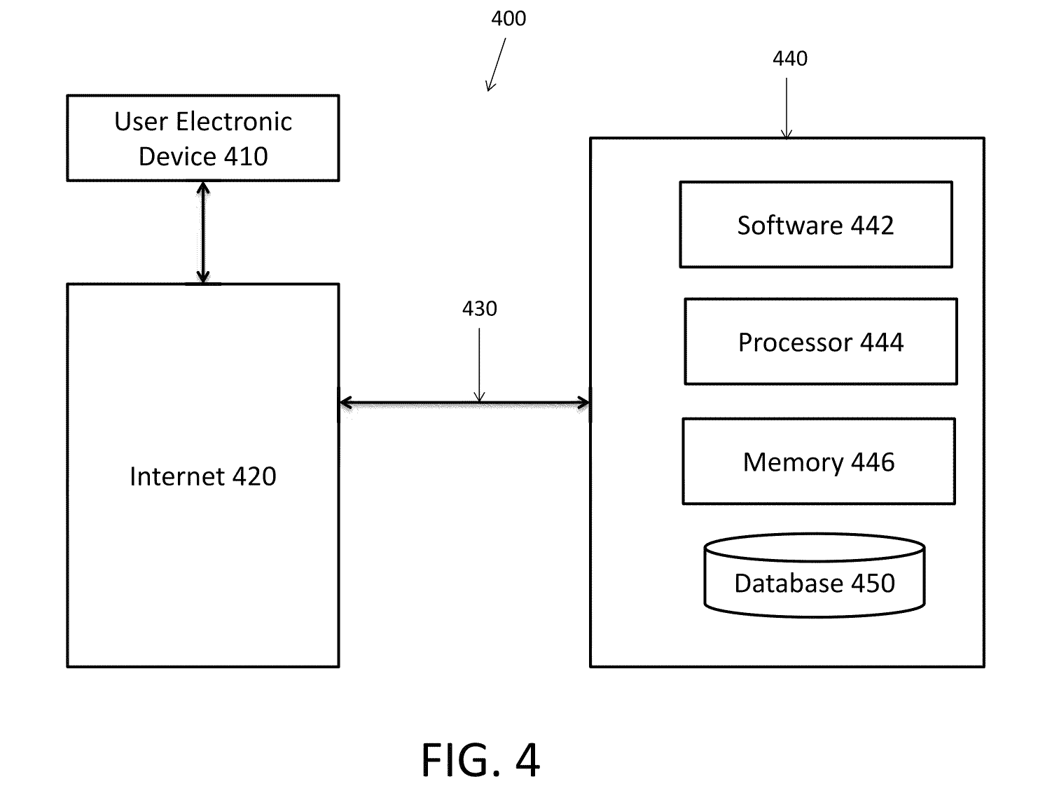

In the depicted example, illustrated in FIG. 4, a network 400 in accordance with the present invention includes a user electronic device 410 and a server computer 440, communicatively coupled via a communication link 430 through a wide area network, such as the Internet 420. The server computer 440 may include a database 450 for storing downloaded digital photograph files and user information, such as, customer order information, account usernames and passwords, customer payment information, email addresses, and the like. The server computer 440 further includes a software application 442 and computer hardware, such as a processor 444 and memory 446. The software application 442 includes computer instructions that control the process described herein below and the computer instructions can be executed by the processor 444 and stored in memory 446. The user electronic device 410 can be any electronic device capable of storing digital photograph files and transmitting the files via the Internet 420. This includes, for example, a cellular telephone, smart phone, computer tablet, personal computer, and the like.

Process for Creating Video Productions

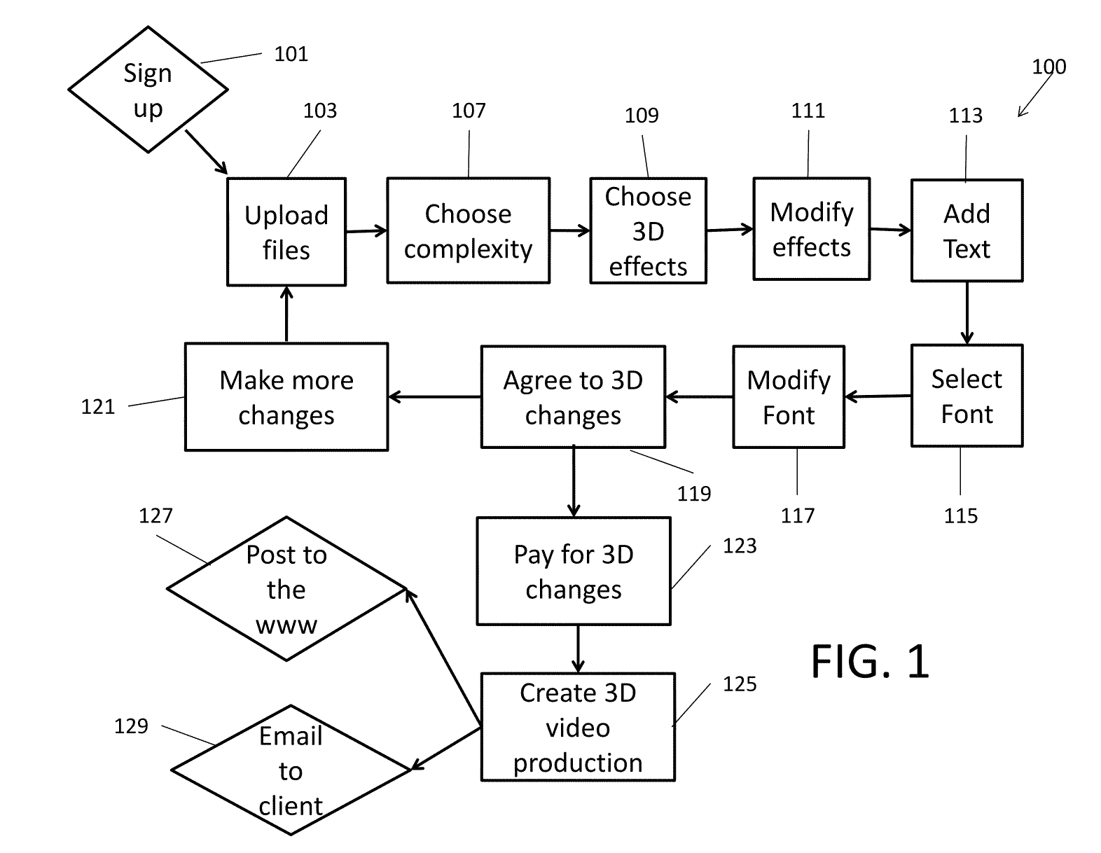

Referring now to FIG. 1, one embodiment of the present invention is shown as a flow diagram. FIG. 1 shows several advantageous steps of the present invention, but, as will be described below, the invention can be provided in several combinations of steps and components, and varying numbers and functions of the components. The first example of a process of the present invention will be described in conjunction with the process flowchart 100 of FIG. 1. Although FIG. 1 shows a specific order of performing steps of the process, the order may be changed relative to the order shown. Also, two or more steps shown in succession may be executed concurrently or with partial concurrence. Certain steps may also be omitted for the sake of brevity. And some steps are merely exemplary steps in an exemplary implementation, but are not required in order to be in accordance with the present invention.

The process illustrated in FIG. 1 begins at step 101, where a user first signs up 101 for an account at a website hosted by the server 440. The account can be associated with a username and password that is either created by the user or assigned to the user. Once the user creates an account, the user can then sign into his or her account using the associated username and password. In step 103, the user uploads at least one digital photograph file from the user electronic device 410. The digital photograph file is transmitted from the user electronic device 410 over the Internet 420 to the server 440, which server 440 then stores the file in the database 450.

In step 107, the user chooses the complexity of editing based on the user's level of computer proficiency, as will be described in more detail below. In step 109, the user chooses visual video effects that will be used in the final video production, and, in step 111, the user may modify the chosen effects, as will be described in more detail below. In step 113, the user adds text by typing in the desired text into a keyboard, touchscreen, or other user interface on the user electronic device 410. The user can select a font for the entered text in step 115 and modify the selected font in step 117. The user can be presented with a confirmation webpage, asking the user to confirm the user's selections, and, in step 119, the user can click a button to agree or confirm the previously selected effects. The user will then have the option to go back and make more changes, or pay for the effects selected. If the user chooses to make more changes in step 121, the process goes back to step 103 and the process starts over from step 103. If the user chooses to pay for the changes, the process continues to step 123, where the user provides payment for the service. After the payment step 123, the process continues to step 125, where the final video production is created in accordance with the user selected options, effects, and/or features, as described herein. The final video production can be created at the server 440 by the processor 444 executing instructions from the software 442. After the final video production is created in step 125, user will have the option to provide the newly created video via email in step 127, or provide the video by posting it on a webpage in step 127, or both.

At least one of the advantages of the present invention is that users can modify and customize every step of the video production. One example is step 107 where the user may choose different levels of involvement with the creation of the video production 125 from simple to near total control of the video's elements. At the simplest level, the user will only be allowed to make simple modifications, such as selecting fonts and backgrounds, cropping his digital photograph files or video, or adding an audio track to the video. At the middle level of complexity, the user may frame his digital photograph files or video, or add his own text to several styles to further customize the video content. For the more advanced level, the user may choose additional special effects to be applied to the video production style, and at this level, the user may also modify the effects, as shown in step 111. For example, in the advanced level, the user may be presented with an option to choose transitions from one photograph to another and an option to animate text and other images in a particular user-selected manner.

Files to be uploaded, as described in step 103, may include an image or photograph, video, and audio, provided in either compressed or uncompressed file formats. Most photograph file formats provide a standardized method of organizing and storing digital images. Image files are composed of digital data in formats that can be rasterized for use on a computer display or printer. An image file may store data in uncompressed, compressed, or vector formats. Once rasterized, an image becomes a grid of pixels, each of which has several bits to designate its color equal to the color depth of the device displaying it. Some of the most common image file formats, which may be used with the present invention, include JPEG/JIFF, JPEG 2000, EXIF, TIFF, RAW, GIF, BMP, PNG, PPM, PGM, PBM, ONN, PAM, WEBP, and the like. There are a multitude of image file types. The PNG, JPEG, and GIF formats are most often used to display images on the Internet. As an alternative embodiment, it is envisioned that if the user uploads a file type that cannot be displayed on a webpage, the software application 442 on the server 440 will convert the file to a format that can be displayed on the webpage.

Another type of file that can be uploaded to the server 440 is an audio file. An audio file format is a file format for storing digital audio data on a computer system. This data can be stored uncompressed, or compressed to reduce the file size. It can be a raw bitstream, but it is usually a container format or an audio data format with a defined storage layer. Allowing the user to upload his own audio files provides the user with the ability to incorporate personal recordings, music, or songs into the final video production. Audio file types include WAV, AIFF, AU, m4a, MPEG-4, MPEG-4 ALS, MPEG-4 DST, WMA, SHN, MP3, VORBIS, MOUSEPACK, AAC, ATRAC, and the like.

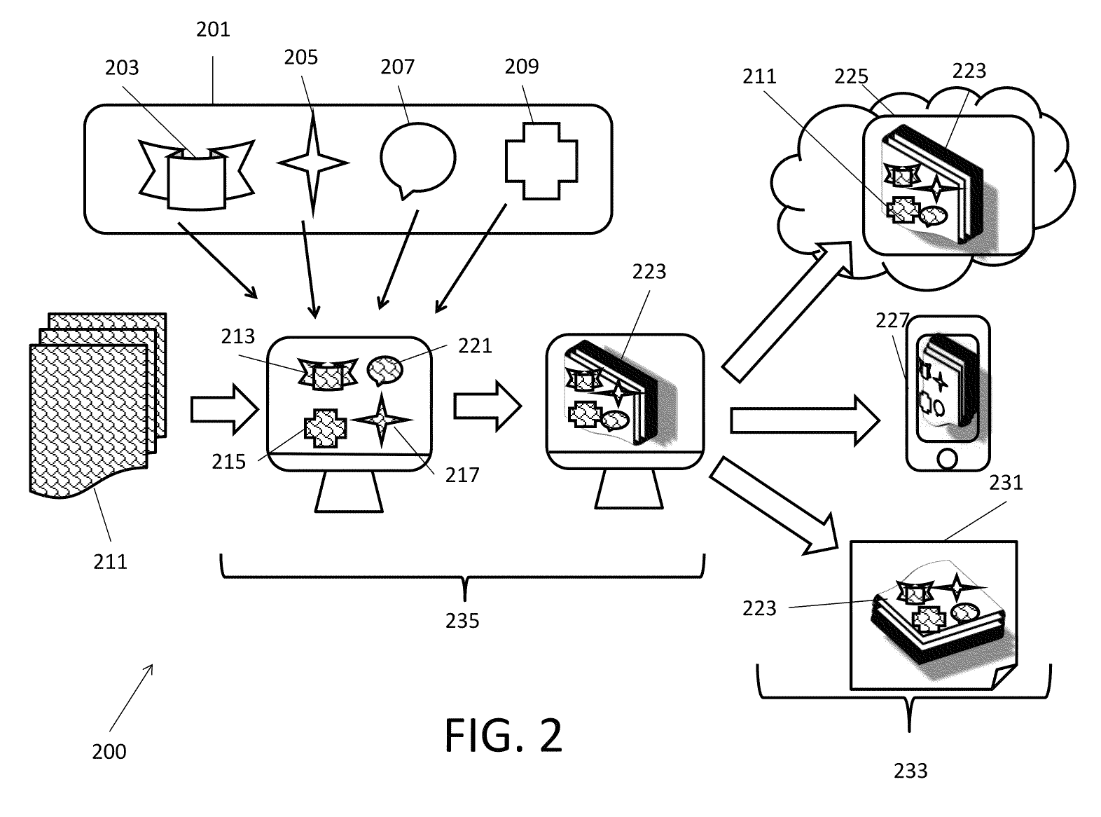

In FIG. 2, a schematic diagram of an exemplary implementation of a system and process 200 of the present invention is presented, illustrating how static 2D digital photographs and audio files are converted into dynamic video productions 223 incorporating 3D features and then distributed to a multitude of electronic devices for viewing. To make a video production 235 in accordance with the present invention using the user's digital files 211, several preprogramed templates 201 can be used. The preprogramed templates 201 are shown as reference numbers 203, 205, 207 and 209. Preprogramed templates 201 have place holders in the software code that can be used with the user's uploaded digital files 211. Once the files 211 are transmitted to the server 440, after being previously chosen by the user, the software 442 inputs the files 211 into the place holders 203, 205, 207 and 209 in the software code. The software 442 then produces or renders the video production 223 with the now filled place holders 213, 221, 215, and 217, using the user's digital photograph files, audio files, selected background, and text files 211.

The empty preprogramed templates 201 are programmed using computer programming languages, known in the art, and may be created using software tools, such as, for example, Adobe Photoshop. One method of creating empty templates 203, 205, 207 and 209 is performed by writing script language to automatically place the files 211 in the placeholders as show in 213, 221, 215, and 217. A script language is a programming language that supports scripts, which are programs written for a special run-time environment that can interpret (rather than compile) and automate the execution of tasks that could alternatively be executed one-by-one by a human operator. Environments that can be automated through scripting include software applications, web pages within a web browser, the shells of operating systems (OS), and embedded systems. As a non-limiting example, the empty preprogrammed templates 203, 205, 207 and 209 can include instructions providing the following exemplary video features: simulating movement of the still digital photograph in 3D space, presenting the digital photograph as a 3D object (such as a cube), framing the digital photograph, adding text in various text styles to the video production, providing moving animation of the digital photograph, providing enhanced video graphics, text art, animated text, images, and the like. Hence, one of the advantages of rendering the video production 223, with the now filled placeholders 213, 221, 215, and 217, is that a novice user with a low level of computer proficiency can produce dynamic videos presenting 2D still digital photographs in a video simulating three dimensional movement, with minimal effort. And, as shown previously in FIG. 1, the user can input an audio file, such a song or personal audio recording, and text, making it part of the final video production 223 as shown in FIG. 2.

After the final video production 223 is complete, distribution 233 is accomplished by creating a website 225 that displays the video production 223. The created website 225 can be hosted by the server 440 and may remain active for a limited amount of time. As an alternative, the user may send the final video production 223 via email 231, or to a cellular phone 227 directly. The video production 223 may also be automatically posted on the user's social networking website account, such as, for example, an Instagram, Vimeo, Youtube, Facebook, or Twitter account.

At least one of the objects of the invention is to produce a custom website 225 that incorporates the uploaded files 211. The website then becomes the conduit for mass distribution at a minimal cost. At the end of production 235, as shown in FIG. 2, each video can be embedded into the HyperText Markup Language (HTML) code of the hosted website allowing the video production 223 to be distributed with ease. Also at the end of production 235, the client can be notified by email that their video is complete and a link, such as a hyperlink, to the hosted custom website can be included in the text of the email 231. It is intended that the embedded video production 223 will automatically play in any browser. The user will be able share the video production 223 with a plurality of individuals simultaneously by forwarding the email 231 to the email addresses of people that the user desires to view the video. The created video production 223 is delivered in a format suitable for cell phone 227 transmission and viewing. The user may also be presented with an option to convert the video production 223 into a screen saver.

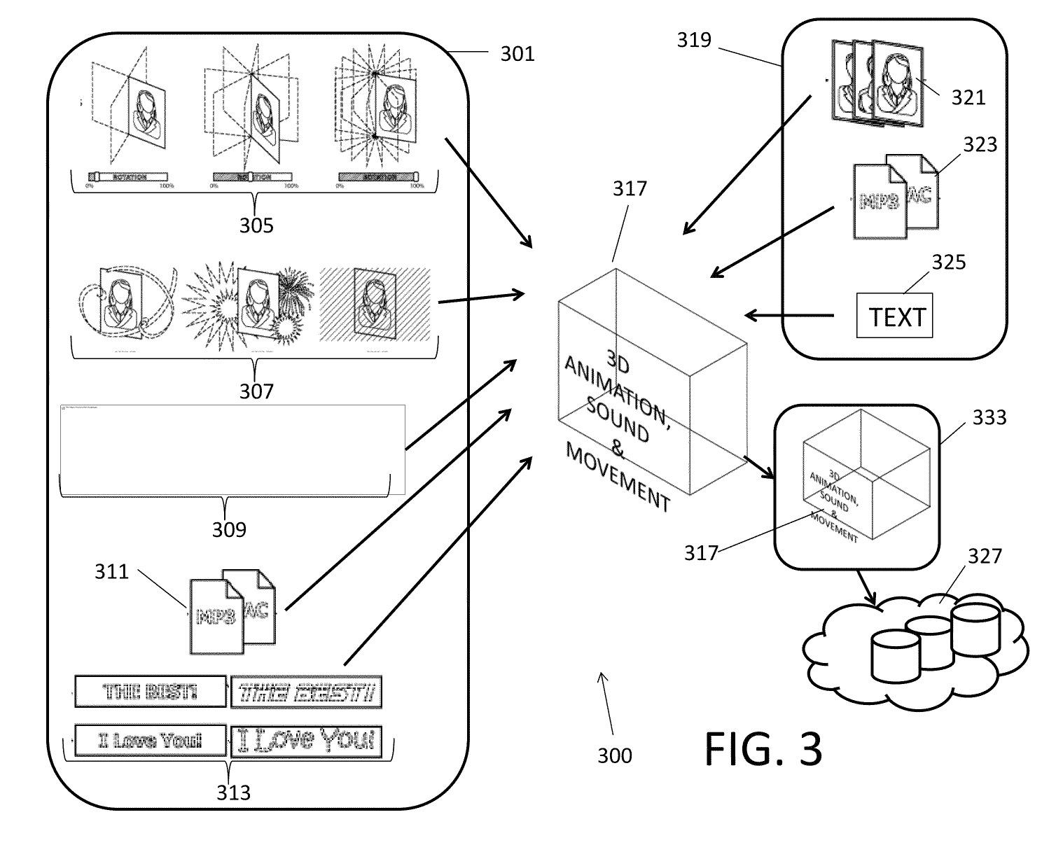

Referring now to FIG. 3, a schematic diagram of an exemplary system and process 300 of the present invention is presented. The system 300 includes a set of preprogrammed features 301 that the user can select for a three dimensional video production 317. The video production 317 is considered three dimensional because the production utilizes 2D personal digital photograph images 321 and presents these images as objects moving in 3D space. For example, as illustrated in FIG. 3, the digital photograph 321 can be a portrait of a loved one. The portrait can be downloaded to the server 440, processed by the processor 444 in accordance with instructions provided by the software 442, and the final video production 317 produced, such that the 2D portrait appears to be moving in 3D space. As shown in FIG. 3, the portrait can be presented in the video 317 as, for example, rotating about a vertical axis (see element 305), or otherwise moving in a three dimensional manner. This provides an alternative method of presenting personal digital photographs 321 that is more dynamic than the prior art 2D digital photograph. Another advantage provided by the present invention is the customization of the available features and user interface to the user's computer proficiency level, as will be described in more detail below. Although embodiments of the present invention are described with reference to personal digital photographs 321, it is understood that other embodiments may include digitally recorded personal events in the form of a personal video.

The three dimensional video production 317 is accomplished by the input of two main sets of elements. The first set of elements are the input personal digital files 319 uploaded by the user. The input personal files 319 may include digital photograph files 321, audio music files 323, and text 325. The second set of elements includes features 301 already preprogramed in the software 442. The preprogramed features 301 include templates with a plurality of levels of difficulty. Non-limiting examples of the levels of difficulty include: the producer level 305, the director level 307, and the special effects level 309. Other preprogramed features 301 include music files 311 and text art 313 stored on the server database 450.

Because of the many alternatives, users may modify and customize their video production 317 depending on their level of knowledge of the software, their desired level of control of the video production, and/or their level of computer proficiency in general. For a more advance user, at the special effects 309 level, the user may choose additional special effects to be applied to the video production 317 style, and even modify the effects after viewing a version of the video. Some modifications include the ability to control speeds, or lighting, which is accomplished by using a variable slider. For example, to control the effect being adjusted, a user may input a choice from 1, for low or slow, to 10 for, high, bright, or fast, and the system 300 will change the video production 317 output accordingly. The variability will give the user the ability to play a video at alternative speeds, thus changing the length of the video, or playing it in slow motion. Another example uses variable masking to allow the user to select the center of influence and control of the mask shape. A mask shape allows the user to put portions of the photograph 321, for example, a face of a portrait photograph 321, inside heart shapes, circles/bubbles, and the like. It is envisioned that other effects can be controlled in a similar manner, for example: background color, amount of blur, types of blurring effects, displacement effects on images, sweeping movements, transition effects, and the like.

For the least experienced users, there are two sub categories of production: producer 305 and director 305. At the director level 307, the middle level of complexity, the user may frame his photograph or video 321 and/or add his own text 325 in several different styles. This allows the user to further customize the video presentation of the user's personal files 319, the placement of which is demonstrated in the style chosen. At the producer 305 level, the simplest level of complexity, the user may make simple modifications of fonts and backgrounds, crop his photograph or video 321, and add an audio track 323 or text 325. This level may also be chosen by users with high computer proficiency and who want to provide a dynamic way of presenting personal photographs, but do not desire the time commitment required to be more involved in the editing process.

Throughout the system 300, the preprogrammed features 301 that are available to the user will be configured for the particular level of complexity selected by the user. For example, features 301, for the least experienced users, may include an easy crop (not shown) of the digital photograph 321. To easy crop the digital photograph 321, the user will be allowed to create a “bounding box” that can be dragged into the desired position and then used to crop the image presented in the photograph 321. The advance counterpart to the easy crop feature, can be an advanced crop feature, which will allow the user to drag on the photograph 321 to create a ratio controlled “bounding box” that can be moved and resized at will for the desired crop. The advanced feature provides more flexibility and choice in editing, but can also be more complicated to use. Accordingly, more advanced users are able to receive the flexibility and choice they desire, while less proficient users can receive the very simplistic editing interface they desire.

After the three dimensional production 317 is complete and approved by the user, the software system 300 will create a webpage 333 to be displayed via the Internet 327. The system 300 will provide the choice for a plurality of styles of webpages 333, which will display and play the video production 317 on the webpage 333. The user may also select images stored on the database 450 of the server 440 to further personalize the webpage 333 to his own individual style or event associated with the photographs 321. For example, if the event associated with the user's photographs 321 is a holiday, the user may select various holiday images stored on the database 450 to be displayed on the webpage 33. As with the photographs 321, the pre-stored database images can also simulate 3D movement in the final video production 317.

A software system has been disclosed that will produce broadcast quality 3D video animations for ordinary people. The user can use the video production as screen savers or as cell phone wallpapers. Personal events such as births and wedding announcements, holiday greetings, special announcements, advertisements, and much more can be presented in a dynamic manner with little effort and cost. A user can choose the difficulty of production from unique and varied styles. A user can also upload photographs and an audio files to produce spectacular video productions. Many styles also offer textural inputs to further customize the 3D videos productions. The animation can be delivered via an email containing the link to a personalized website video page. From the personalized website video page friends and family can instantly view the customized 3D video production.

What is claimed is:

1. A method of providing and distributing personal video content that displays personal digital photographs as still images moving in three dimensional space, the method comprising steps of:
sending a digital personal photograph to a server;
identifying a level of editing complexity from a plurality of levels of editing complexity;
editing at the identified level of editing complexity by selecting a three dimensional effect desired for a personal video from a plurality of preprogrammed templates stored at the server;
receiving a link to a website including the personal video, wherein the personal video displays the digital personal photograph as a still image moving in three dimensional space according to the selected three dimensional effect; and
forwarding the link to a personal electronic device associated with a desired viewer.

2. The method of claim 1, wherein the link is a hyperlink.

3. The method of claim 1, wherein the step of receiving the link further comprising the step of receiving an email including a hyperlink to the website and wherein the website is hosted by the server.

4. The method of claim 1, wherein the step of sending the digital personal photograph further comprises the step of sending an audio music file and wherein the audio music file is included in the personal video.

5. The method of claim 1, wherein the step of sending the digital personal photograph further comprises the step of sending text and wherein the text is included in the personal video.

6. The method of claim 1, wherein the plurality of levels of editing complexity include a beginning level, an intermediate level, and an advanced level.

7. The method of claim 1, wherein the three dimensional effect includes rotating the digital personal photograph.

8. A method of providing and distributing personal video content that displays personal digital photographs as still images moving in three dimensional space, the method comprising steps of:
receiving a digital personal photograph at a server from a user electronic device;
storing the digital personal photograph in a database of the server;
receiving a level of editing complexity selected by a user of the user electronic device from a plurality of levels of editing complexity;
providing editing options to the user in accordance with the selected level of editing complexity;
receiving an editing option selected by the user, wherein the selected editing option includes a three dimensional effect for a personal video;
creating the personal video displaying the digital personal photograph as a still image moving in three dimensional space according to the three dimensional effect; and
sending a link to a website including the personal video to the user.

9. The method of claim 8, wherein the link is a hyperlink.

10. The method of claim 8, wherein the step of sending the link further comprising the step of sending an email including a hyperlink to the website and wherein the website is hosted by the server.

11. The method of claim 8, wherein the step of receiving the digital personal photograph further comprises the step of receiving an audio music file and wherein the audio music file is included in the personal video.

12. The method of claim 8, wherein the step of receiving the digital personal photograph further comprises the step of receiving text and wherein the text is included in the personal video.

13. The method of claim 8, wherein the plurality of levels of editing complexity include a beginning level, an intermediate level, and an advanced level.

14. A method of providing and distributing a personal video production that displays digitally recorded personal events as moving in three dimensional space, the method comprising steps of:
sending a digitally recorded personal event file to a server, wherein the digitally recorded personal event file is one of a digital photograph and a personal video;
identifying a level of editing complexity from a plurality of levels of editing complexity;
editing at the identified level of editing complexity by selecting a three dimensional effect desired for the personal video production from a plurality of preprogrammed templates stored at the server;
receiving a link to a website including the personal video production, wherein the personal video production displays the digitally recorded personal event file as an image moving in three dimensional space according to the selected three dimensional effect; and
forwarding the link to a personal electronic device associated with a desired viewer.

15. The method of claim 14, wherein the link is a hyperlink.

16. The method of claim 14, wherein the step of receiving the link further comprising the step of receiving an email including a hyperlink to the website and wherein the website is hosted by the server.

17. The method of claim 14, wherein the step of sending the digitally recorded personal event file further comprises the step of sending an audio music file and wherein the audio music file is included in the personal video production.

18. The method of claim 14, further comprising the step of sending text input and wherein the text input is included in the personal video production.

19. The method of claim 1, wherein the plurality of levels of editing complexity include a beginning level, an intermediate level, and an advanced level.

20. The method of claim 1, wherein the three dimensional effect includes rotating the digitally recorded personal event file image.
